(19) United States
(12) Patent Application Publication
(10) Pub. No.: US 2004/0261532 A1
(43) Pub. Date: Dec. 30, 2004

(54) Method and apparatus for multilayer thickness measurement

(75) Inventors: Douglas Sabin, Marblehead, MA (US); Paul Gurrisi, Kingston, NH (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Kortec, Inc., Ipswich, MA (US)

(21) Appl. No.: 10/828,389

(22) Filed: Apr. 19, 2004

Related U.S. Application Data
(60) Provisional application No. 60/463,598, filed on Apr. 17, 2003.

(51) Int. Cl. G01N 29/04

(52) U.S. Cl. 73/627

(57) ABSTRACT

A measurement method and apparatus for measuring the thickness of a layered material such as a co-injection preform to be used in injection molding or blow molding of articles. One exemplary method includes applying a killing function to reduce the ringing associated with projection and measuring of wave energy. A second exemplary method includes summing characteristic function to determine the thickness of the core.

### RELATED APPLICATIONS

This application claims priority under 35 U.S.C. § 119(e) to U.S. Provisional Application Ser. No. 60/463,598, entitled “Method and Apparatus for Multilayer Thickness Measurement,” filed on Apr. 17, 2003, which is herein incorporated by reference in its entirety.

### BACKGROUND OF INVENTION

It is known in the art of injection molding of vessels such as bottles, tubes and the like, to produce such vessels by injection molding or blow molding of suitable materials into a mold. It is also generally known in the field of co-injection molding to co-extrude two or more streams of plastic or other materials in order to produce molded preforms which can be blow molded and or injection molded to produce vessels, such as those mentioned above, containing multiple layers of material. A method and apparatus for producing such multiple layer preforms is disclosed in U.S. Pat. Nos. 5,914,138 and 6,187,241 assigned to Kortec, Inc. of Beverly, Mass., the entire disclosures of which are incorporated herein by reference.

As noted in the aforementioned patents, in each co-injection nozzle, at least two materials are combined using a co-injection nozzle design that allows the at least two different types of resins to be combined in a controlled way so that a single at least three layer melt stream is created. In usual practice, the inner and outer layers are of the same skin material while the interior layer “sandwiched” between the two is of a different composition. The interior layer is commonly referred to as a core layer.

It is desirable in the manufacture of such multi-layer articles to be able to precisely control the thickness of the three layers, as the thicknesses of the various layers will affect the characteristics of the completed molded preform, as well as any vessel produced therefrom. For example, in some applications, the interior sandwiched material may operate as a barrier layer to block UV radiation or to reduce gas permeability. The interior layer may also act as an oxygen scavenger to prevent oxygen from the atmosphere from reaching the contents of the container. The thickness of the material in the inner layer will affect the extent to which the core is effective in blocking UV radiation or reducing gas permeability.

While the apparatus described in the aforementioned patents and article are effective to produce precise layer thicknesses throughout the molded article, in some applications, it is nevertheless desirable from time to time to test or measure the thickness of these layers. This may prove difficult using mechanical or visual measurement devices for reasons well known to those skilled in the art. Another measurement method comprises ultrasonic measurement. However, measurements using ultrasound have proven difficult and inaccurate.

### SUMMARY OF INVENTION

The present invention relates to a measurement method and apparatus that determines the thickness and placement of a layer of a preform (or co-injection article), such as the core layer (usually a barrier material), and may be applied to measure the overall thickness of the encapsulating skin layers. A measurement apparatus according to aspects of the present invention may be used to perform statistical process control on the selected preform to establish the quantity and placement of the core material in the preform.

An aspect of the present invention is directed to a measurement system, comprising: an article mount adapted to maintain an article comprising a plurality of layers; a wave energy source arranged to direct wave energy onto the article; a transducer arranged to receive a portion of the wave energy created by the wave energy source after it has interacted with the article and adapted to generate an electronic signal corresponding to the portion of the wave energy; and a processor electronically coupled to the sensor adapted to process the electronic signal to identify the thickness of at least one layer by matching characteristic shapes of an electronic signal generated by the interface between two layers to a signal obtained by the sensor.

In another aspect, the invention is directed to a measurement system, comprising: an article mount adapted to maintain an article comprising an outer skin layer, a core layer and an inner skin layer; an ultrasound source arranged to direct wave energy onto the article; a transducer arranged to receive at least a portion of the wave energy reflected from the article and adapted to generate an electronic signal corresponding to the portion of the ultrasound wave energy; and a processor electronically coupled to the transducer adapted to process the electronic signal to identify a peak corresponding to an interface between the outer skin layer and an outer surface of the core layer, and to determine parameters of a killing or canceling function.

Another aspect of the invention is directed to a method of measuring thickness, comprising: mounting an article comprising a plurality of layers including an outer skin layer, a core layer and an inner skin layer; projecting wave energy onto the article; receiving at least a portion of the wave energy reflected from the article; converting the portion of the wave energy to form an electronic signal; and processing the electronic signal to identify an interface using a feature indicative the interface between two of said plurality of layers, and to determine parameters of a killing function (also referred to as a canceling function). A feature indicative of an interface may include but is not limited to peak in the electronic signal, a change in sign of the first derivative of the signal; a dip in the signal.

This method can use any type of wave energy including light, x-ray and ultrasound. The wave energy may interact with the preform by reflection, refraction, scattering, or a combination of the same. The transducer may create a signal in the time domain such as the amplitude of ultrasonic reflections from the layer interfaces or it may create a signal in the distance domain by moving a wave energy sensitive device across a field of reflected wave energy or by moving the part between the wave energy source and the transducer. A charge coupled device (CCD) may be used to generate a map of wave energy after it has interacted with a multilayer article.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a graphical illustration of an exemplary signal from an ultrasound transducer receiving reflected ultrasound energy from a multilayer article;

FIG. 2 is a graphical illustration of an exemplary signal from an ultrasound transducer receiving reflected ultrasound energy from a multilayer article in which the core layer is relatively thin;

FIG. 3 is a block diagram of an exemplary embodiment of a measurement system according to aspects of the present invention;

FIG. 4A is a side view of an example of a conventional preform which may be measured by systems according to embodiments of the present invention;

FIG. 4B is a cross sectional side view of a conventional preform showing transducer location at various elevations;

FIG. 4C is a top view taken along line 4C-4C in FIG. 4B illustrating four pairs of transducers directed at a given level of the preform at various angles;

FIG. 4D illustrates a measurement apparatus (similar to the apparatus illustrated in FIG. 4B) in greater detail;

FIG. 5 is a flowchart illustrating an exemplary method for facilitating automated measurement of a thickness of a core layer of an article according to aspects of the present invention;

FIG. 6 is a flowchart illustrating an exemplary method for automatically measuring a thickness of a core layer of an article according to aspects of the present invention;

FIG. 7A is a graphical illustration of an expanded view of region 7 (shown in FIG. 2);

FIG. 7B is an exemplary graphical illustration demonstrating how a killing function is applied;

FIG. 7C is a graphical illustration of an exemplary signal from a transducer after modification using a killing function;

FIG. 8 is an expanded view of region 8 of FIG. 1, where the thickness of the core layer has been selected to be large enough to determine the parameters of a killing function;

FIG. 9 is a schematic illustration of apparatus for use with another aspect of the invention for use in measuring the layers of a multilayer article;

FIG. 10A illustrates an example of an electronic signal output from transducer (shown in FIG. 9) containing information to permit a peak corresponding to each of the interfaces in article to be identified;

FIG. 10B illustrates that the electronic signal containing information to permit a peak corresponding to each of the interfaces, and in particular, that the center peak in a signal obtained from the transducer contains information both an skin-core interface and a core skin interface;

FIG. 10C illustrates that a signal may contain a peak corresponding to a skin-core interface and a peak corresponding to a core-skin interface;

FIG. 11 is a flowchart illustrating an exemplary method for measurement of a thickness of a core layer of an article according to aspects of the present invention;

FIG. 12A, illustrates characteristic curves used to form a first estimate of the thickness of the core; and

FIG. 12B, illustrates a summation of the characteristic curves illustrated in FIG. 12A.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present invention relates to a measurement method and apparatus that determines the thickness and placement of at least one of a plurality of layers of a multilayer article (e.g., a preform), and may be applied to measure the overall thickness of the encapsulating skin layers. A measurement apparatus according to aspects of the present invention may be used to perform statistical process control on the selected preform to establish the quantity and placement of the core material in the article.

The statistical process control to establish the quantity and placement of a layer, such as the core material, in the article may be accomplished using standard peak selection algorithms, preferably in combination with a killing or canceling function. This may be accomplished by identifying a region of the signal which is known to have a characteristic shape that represents the location of an interface and consequently canceling the complete signal based on a portion of the signal possibly revealing other characteristic interface shapes that overlap the first characteristic shape.

Alternatively, this may also be accomplished by simultaneously fitting multiple characteristic signal shapes, each representing a signal interface, to establish the signal using an iterative method to minimize the error between the summation of the characteristic shapes and the signal by varying the magnitude and position of each characteristic shape. Several known iterative methods may be applied, including Newton's Method, Euler's Method and the Method of Steepest Decent. Using these methods, when the error between the signal and the combined characteristic shapes is minimized a best solution has been reached and the location of the interfaces can be determined. If the characteristic shapes are accurate the interface location can be determined accurately even if the shapes overlap.

An aspect of the present invention is an apparatus for measuring thickness of a layer in a multilayer article or preform. The system includes an article mount adapted to maintain the article; an energy source arranged to direct wave energy onto the article; a sensor (transducer) arranged to receive a portion of the wave energy created by the energy source after it has interacted with the article and which is adapted to generate an electronic signal corresponding to the portion of the wave energy; and a processor electronically coupled to the sensor adapted to process the electronic signal to identify the thickness of the layers by matching the characteristic shapes of the electronic signal created by the interface between two layers to the signal communicated from the sensor.

Another aspect of the invention is directed to a method of measuring thickness, comprising: mounting an article comprising a plurality of layers including an outer skin layer, a core layer and an inner skin layer; projecting wave energy onto the article; receiving at least a portion of the wave energy reflected from the article; converting the portion of the wave energy to form an electronic signal; and processing the electronic signal to identify a peak corresponding to an interface between two of said plurality of layers, and to determine parameters of a killing function.

The method and apparatus of this invention can use any type of wave energy including light, x-ray and ultrasound. The energy may interact with the article by reflection, refraction, scattering, or a combination of the same. The sensor can create a signal in the time domain such as the amplitude of an ultrasonic reflection from the layer interfaces or it may create a signal in the distance domain by moving a light sensitive device across a field of reflected light. A charged couple device (CCD) may be used to generate a map of wave energy after it has interacted with a multilayer article.

In one example, apparatus according to aspects of the present invention use an ultrasound source to send an impulse into an article under test (e.g., a preform or other multilayer article), and a transducer and processor to receive and process a portion of ultrasound energy reflected from the article. There are a number of interfaces which the ultrasound energy from the ultrasound source will encounter. For example, in a three-layer article, first there is an outer skin interface which is formed by an outer skin layer and, for example, air, gel or water, in which the article may be maintained during measurement. A second interface, referred to as an outer skin layer-core interface, follows the skin interface, and is formed where the skin material transitions into the core material. A third interface, referred to herein as a core-skin interface, is formed where the core material transitions into the inner skin layer. Finally, a fourth interface, referred to as an inner skin interface, is formed where the ultrasound wave leaves the inner skin material and enters the interior of the article. At each of the above interfaces, a change in acoustic impedance is encountered by the ultrasonic wave, resulting in a reflection of a portion of the ultrasound energy, which travels back to the transducer, and as described in greater detail below, is converted to an electronic signal and processed according to aspects of the present invention.

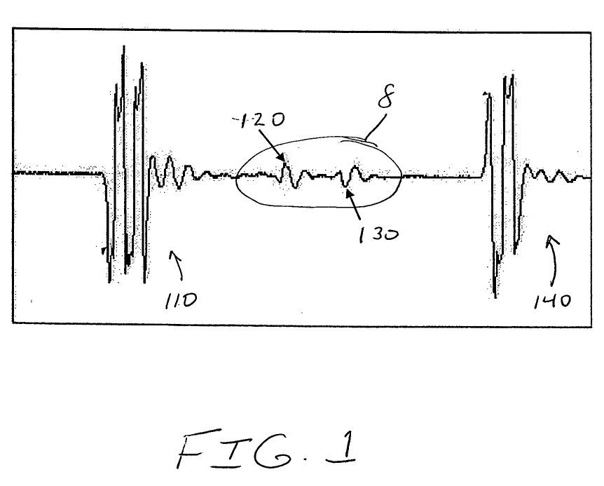

FIG. 1 is a graph illustrating an exemplary signal from an ultrasound transducer receiving reflected ultrasound energy from a multilayer article. For a three-layer article, as discussed above, the return signal will have four components created at the interfaces noted above: an outer skin interface component 110, an outer skin-core interface component 120 (or simply skin-core interface), core-skin interface component 130 and core-inner skin interface component 140 (or simply core-skin interface). Each component may be described as including a damped oscillation.

The peaks associated with the core layer are readily identifiable, although the specific peaks corresponding to the edges of the core layer are more difficult to identify. Typically, in a three layer preform, the peaks associated with the core layer 120, 130 are relatively small compared to the peaks corresponding to the outer surface of the outer skin layer 110 and the peaks corresponding to the inner surface of the inner skin layer 140 because the impedance difference between the core layer and the surrounding skin layers are relatively small compared to the impedance differences between the outer skin layer (or inner skin layer) and any surrounding air, water, etc. Accordingly, the amount of the ultrasound wave energy reflected at the core interfaces is relatively small.

It is to be appreciated that the leftward portion of the graph corresponds to the outer surface of the article, and moving right to left is referred to herein as moving in an outward direction. The rightward portion of the graph corresponds to the inner surface of the article, and moving left to right is referred to herein as moving in an inward direction.

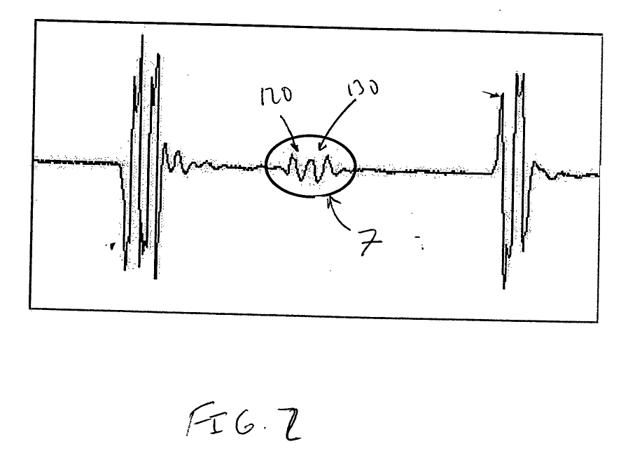

When measuring some articles using ultrasound, a problem may arise due to the core layer being too thin. In such circumstances, as illustrated in FIG. 2, the tail of the skin-core interface component 120 overlaps the core-skin interface component 130. This overlap can have several effects that tend to be more severe as the core layer thickness is reduced. For example, the signal corresponding to the core-skin interface may be shifted, reduced or enlarged, or otherwise obscured, thus resulting in an imprecise measurement of core thickness. Accordingly, overlapping components can makes thickness measurement of the core difficult.

Problems arising from such overlap may be reduced or eliminated using the following exemplary technique in accordance with aspects of the present invention. A peak in the signal corresponding to the skin-core interface is determined using standard peak selection algorithms. As described in greater detail below, a “killing function” is then used to subtract a characteristic signal shape representing a single interface component from the signal. A killing function is defined herein as any function used to remove or substantially reduce a portion of a selected signal shape representing a single interface component from the signal. According to aspects of the present invention, a killing function is selected that approximates the ringing (i.e., resonance phenomenon) associated with projecting ultrasound energy on an interface of a multilayer structure and/or detecting a portion of the ultrasound energy using a transducer. In some embodiments, after subtracting the killing function from a signal from a transducer, only the second signal plus any error in the estimated signal remain. Accordingly, a peak corresponding to the location of the inner surface of the core layer can be more accurately determined using standard peak selection algorithms.

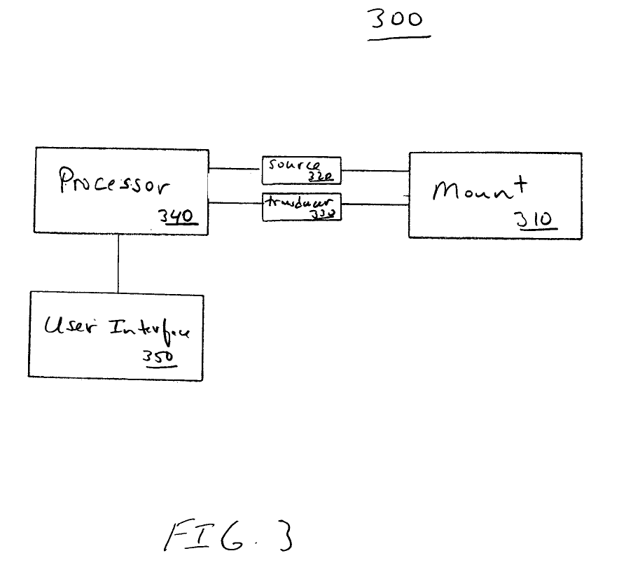

FIG. 3 is a block diagram of an exemplary embodiment of a measurement system 300 according to aspects of the present invention. Measurement system 300 includes an article mount 310, a wave energy source 320, an at least one transducer 330, a processor 340, and a user interface 350.

An article mount 310 is adapted to maintain an article. For example, the article may be a preform comprising an outer skin layer, a core layer and an inner skin layer. Mount 310 may be configured in any suitable manner to maintain an article for measurement. Preferably the mount is stable so as to prevent movement that may render any measurement inaccurate. In some embodiments, measurements may be performed in water or a suitable gel. Accordingly, mount may be adapted for use in water or a suitable gel. In some embodiments, the mount may be adapted to move articles, in succession, to a location to be measured. For example, the mount may comprise a conveyor system.

Wave energy source 320 is arranged to direct ultrasound wave energy onto an article maintained by mount 310. Wave energy source may comprise any suitable source of ultrasound wave energy.

Transducer 330 is arranged to receive at least a portion of the wave energy reflected from the article. Transducer 330 may be any suitable transducer of wave energy capable of generating an electronic signal corresponding to the reflected portion of the wave energy.

Source 320 and transducer 330 may be arranged to form one or more pairs such that a source comprising a pair projects wave energy on a selected portion of the article and the transducer is arranged to receive at least a portion of the wave energy reflected by the article. The source and transducer comprising the pair may be discrete or may be combined in a single apparatus. For example, in some embodiments, ultrasound wave energy source 320 and transducer 330 may be combined in a single apparatus, such as a conventional ultrasound pulser/receiver, in which the transmission of ultrasound energy and the receipt of ultrasound energy is multiplexed. In some embodiments, the rate of multiplexing is selected so as to alternate between pulsing and receiving in a manner such that a reflected portion of ultrasound energy projected onto the multilayer article can be received from all interfaces associated with the multilayer structure, to obtain a signal as illustrated in FIG. 1. Accordingly, as one of ordinary skill in the art would understand, the rate of multiplexing is selected based on the thickness of the article and the materials comprising the article.

Processor 340 is electronically coupled to transducer 330 and is adapted to process the electronic signal produced by the transducer to determine a thickness of the core layer, for example, using a method as described in greater detail below. Processor 340 is selected to operate at a suitable speed such that the signal may be adequately sampled to determine the thickness of the core. For example, processor 340 may include a high-speed data acquisition card. The signal produced by the transducer may be digitized by the transducer or the processor or any other suitable device. A user interface 350 may be included to control the processor.

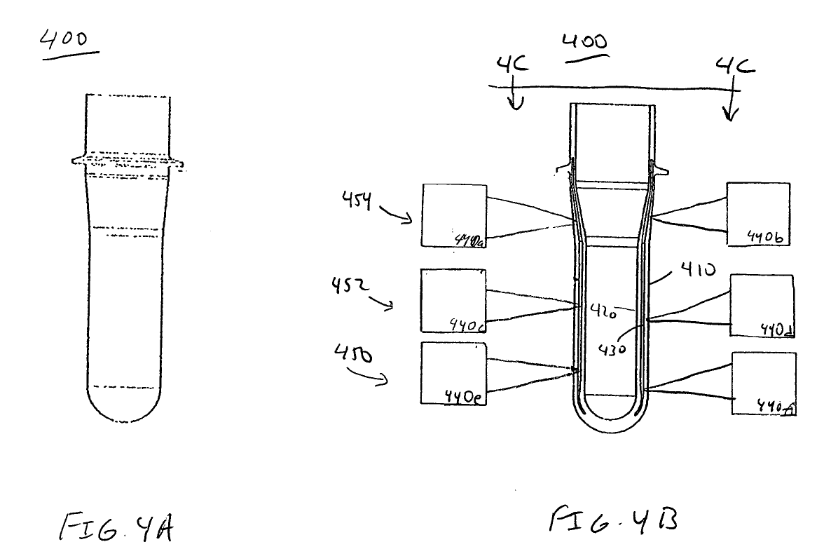

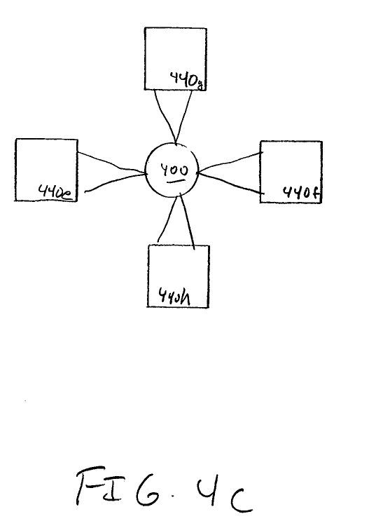

FIG. 4A is a side view of an example of a conventional preform 400 which may be measured by systems according to embodiments of the present invention. Preform 400 is shown merely for illustrative purposes. Any suitable preform or other article now known or developed in the future having any suitable shape, and made of any suitable materials may be measured using the methods and apparatus according to the present invention.

FIG. 4B is cross sectional side view of preform 400. FIG. 4B illustrates an outer skin layer 410, an inner skin layer 420 and a core layer 430. Typical thicknesses of the core layer 0.15-0.40 mm, which typically represents the smallest dimension to be measured on a given preform. A plurality of source/transducer pairs 440a-440l may be arranged to project and receive ultrasound wave energy. In the illustrated embodiment, twelve source/transducer pairs are present, with four source/transducer pairs located at each of three levels bottom 450, middle 452, and top 454. Although twelve source/transducer pairs are shown, any suitable number of sources and transducers (one or more of each) may be used. An apparatus for measuring thickness is illustrated in greater detail with reference to FIG. 4D below. FIG. 4C is a top view taken along line 4C-4C in FIG. 4B illustrating four pairs directed at a given level of the article. As illustrated in FIG. 4B, in some embodiments, it has been shown to be effective to focus the ultrasound wave energy at the core layer or in proximity thereto.

To obtain a suitable signal from a transducer, for measurement according to the present invention, one of ordinary skill in the art would understand that the sampling rate for which data is obtained is determined using conventional techniques. For example, articles having typical core thickness, as mentioned above, may be sampled at a rate of 250 MHz to obtain suitable information about the location of the interfaces. Additionally, to facilitate measurement, it may be desirable to perform high pass filtering of the signal from a transducer, low pass filtering of the signal, and/or averaging of a plurality of signals from a given transducer.

FIG. 4D illustrates a measurement apparatus (similar to the apparatus illustrated in FIG. 4B) in greater detail. Source/transducers 440a-440f are maintained in a rigid housing. In some embodiments, each source/transducer has a same focal length. Accordingly, as illustrated in FIG. 4D, in such embodiments, if the diameter of the article is different at various levels, the location of transducers may be selected such that the focal point of the wave energy is on the core layer.

An alignment apparatus 470a-470b made of a suitable rigid material may be used to help ensure that the focus of the wave energy apparatus is at the core of the multilayer article 480. A holding apparatus may be used in combination with alignment apparatus, to facilitate handling of the article. In some embodiments, for example, apparatus using ultrasound measurement techniques, the alignment apparatus may be sealed to maintain a liquid 490 such as water.

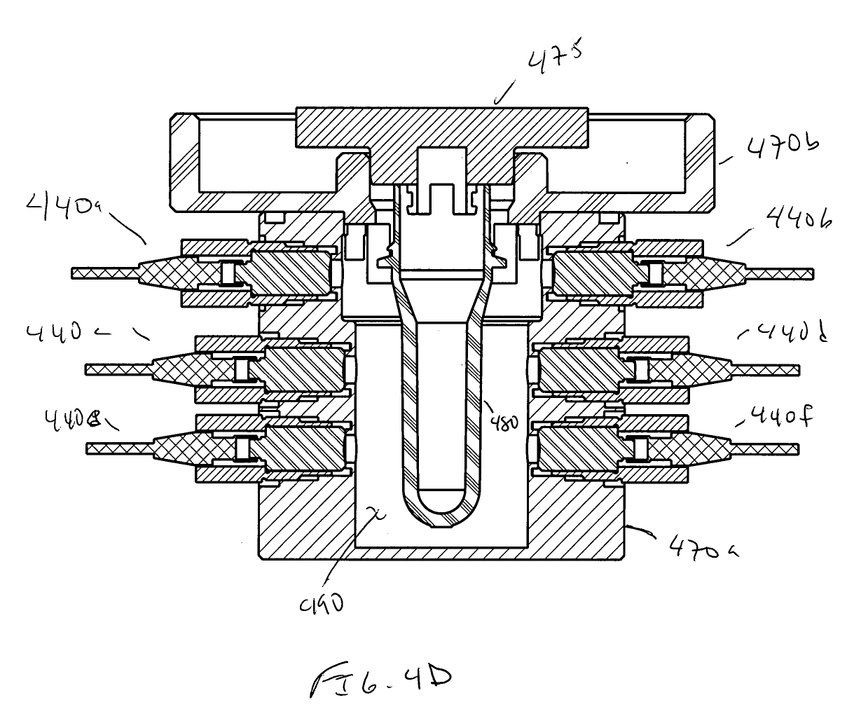

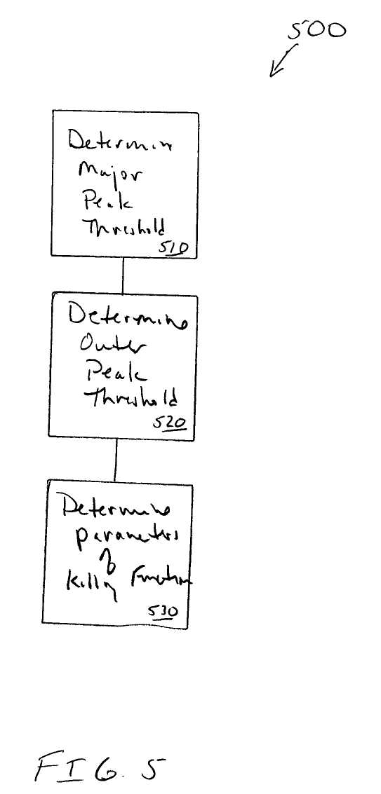

FIG. 5 is a flowchart 500 illustrating an exemplary method for facilitating automated measurement of a thickness of a core layer of an article according to aspects of the present invention. According to the method of facilitating measurement, parameters are determined such that the parameters can be implemented to control a processor and associated hardware (e.g., as illustrated in FIG. 3 above) to automatically measure thickness of the core layer using a signal from a transducer. Automatic measurement is discussed in greater detail below with reference to FIG. 6.

At step 510, a major peak threshold is set. As described below with reference to FIG. 6, peaks in a signal from a transducer having amplitudes less than the threshold are eliminated because they are assumed to arise from spurious events (e.g., artifacts of ultrasound detection). It is to be appreciated that the major peak threshold is set using knowledge available to one of ordinary skill in the art, who would have a priori knowledge regarding which peak is the peak corresponding to the outer core surface using visual inspection. Alternatively, if the peak corresponding to the outer surface of the core were not identifiable by visual inspection, a major peak threshold could then be selected experimentally. For example, a signal could be obtained from the article and then the article could be sliced and measured to determine which peak corresponds to the outer surface of the core and which are spurious.

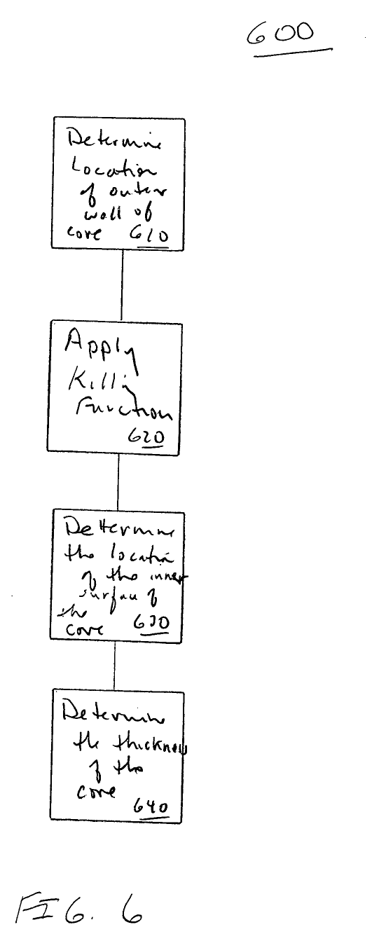

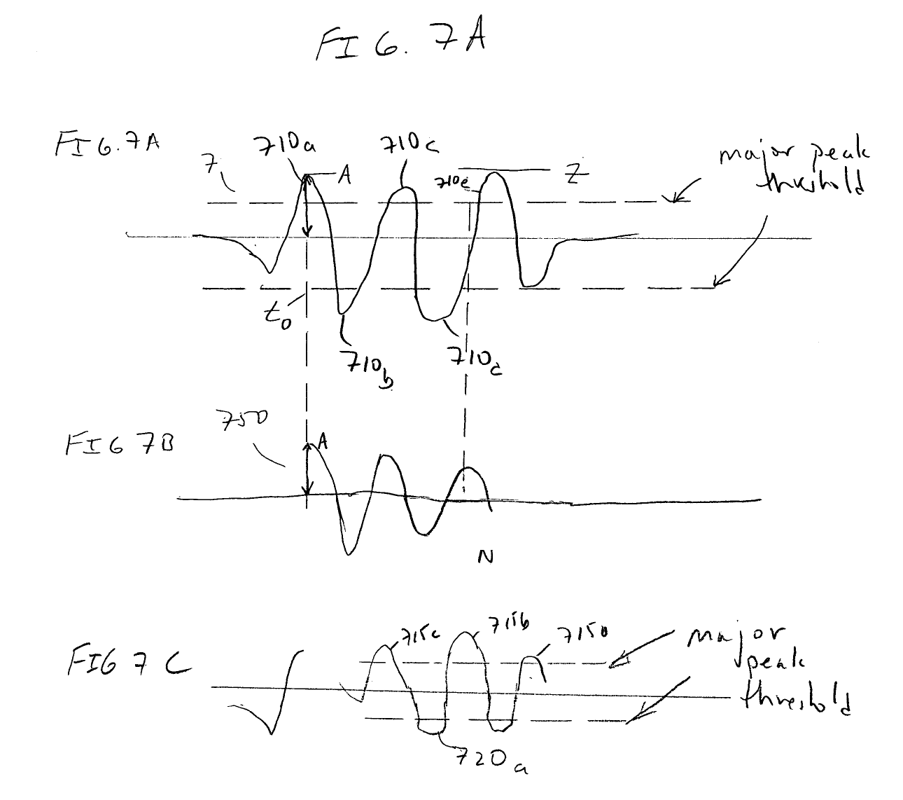

Peaks 710a-e having amplitudes greater than the threshold are referred to herein as “major peaks.” For example, the major peak threshold may be selected as a percentage of the maximum peak (Z) that is in the portion of the signal corresponding to the core layer. Maximum peak (Z) may have a positive amplitude or a negative amplitude. Typically the threshold is set at 30-50% of the maximum peak (Z). FIG. 7A is a graphical illustration of an expanded view of region 7 (shown in FIG. 2).

At step 520, an outer surface threshold is set to determine which of the major peaks 710a-e corresponds to the outer surface of the core. It is known from experience that the outer surface of the core will correspond to one of the first two major peaks 710a, 710b in the signal (i.e., one of the peaks corresponding to the outside of the core). Specifically, if the amplitude of the first major peak 710a is greater than a selected percentage of the amplitude of the second major peak 710b, the first major peak corresponds to the location of the outer surface of the core. If the first major peak is less than the selected percentage of the amplitude of the second major peak, the second major peak corresponds to the location of the outer surface of the core. The percentage is referred to as the outer surface threshold. The percentage is referred to as the outer surface threshold.

As stated above, the peak corresponding to the outer surface of the core is visually identifiable by one of ordinary skill in the art or experimental data. Accordingly, the first peak major peak amplitude threshold is selected such that the proper peak is selected as the outer surface of the core. Typically, the threshold is set at 70-90%.

At step 530, parameters of a killing function are determined such that the resulting killing function can be used to eliminate the spurious signal components associated with ringing associated with ultrasound wave energy projected on an interface and detected by a transducer. Use of the killing function is discussed in greater detail below with respect to FIG. 6.

An exemplary killing function Y(t) according to aspects of the present invention is a linearly decaying sinusoid (also referred to as a damped harmonic) given by the following equation.

$$Y ( t ) = A cos ( \frac{2 π t}{T} ) ( \frac{{t}_{t} - t}{{t}_{t}} )$$

where

t=time

Y(t)=Estimated signal

A=Amplitude of the peak corresponding to the outer surface of the core layer to which the killing function is to be applied.

T=Estimated period of time between the peak corresponding to the outer surface of the core layer and the following peak in time having the same polarity as the peak corresponding to the outer surface of the core layer.

tₜ=Duration of the ringing corresponding the outer surface of the core layer, and

(tₜ−t)/tₜ is referred to as the damping coefficient.

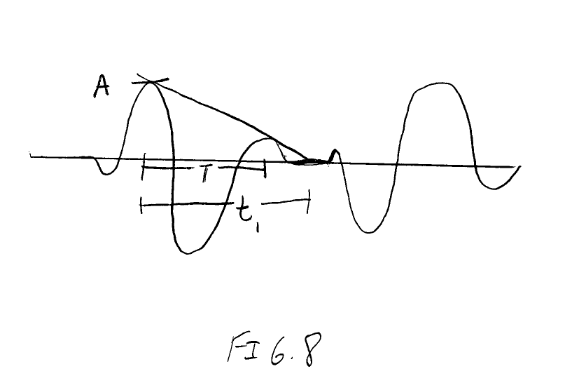

The values of parameters T and tₜ can be determined experimentally by measuring a sample article comprised of skin layer and core layer that are similar in material and dimension as those of the preform to measured, and where the core layer is selected to be thick enough that the ringing associated with the outer surface of the core does not overlap the signal associated with the inner surface of the core layer (for example, see FIG. 1). A core thickness of greater than about 0.008 inches is typically adequate to avoid overlap of the signals. FIG. 8 is an expanded view of region 8 of FIG. 1, where the thickness of the core layer is large enough to determine the parameters of a killing function. Each of parameters T and tₜ are illustrated in FIG. 8.

In some embodiments, the damping coefficient may be a polynomial of the form ((tₜ−t)/tₜ)ⁿ. The term “n” can be any suitable number that suitably damps the harmonic associated with ringing.

FIG. 6 is a flowchart 600 illustrating an exemplary method for automatically measuring a thickness of a core layer of an article according to aspects of the present invention. The method illustrated in FIG. 6 can be executed by a suitably programmed processor (shown in FIG. 3) using conventional peak detection algorithms.

At step 610, the location of the outer surface of the core layer is determined by selecting a peak corresponding to the outer surface of the core in a signal from a transducer. As stated above, the peaks considered are the first two major peaks encountered when moving along the signal in direction left to right (i.e., the first two peaks in the portion 120 in FIG. 1). The two major peaks will have opposite polarities (i.e., one will have a negative amplitude and one will have a positive amplitude.)

Also as stated above, if the amplitude of the first major peak is greater than a selected percentage of the amplitude of the second major peak (i.e., greater than the outer surface threshold), the first major peak corresponds to the location of the outer surface of the core; and if the first major peak is less than the selected percentage of the amplitude of the second major peak, the second major peak corresponds to the location of the outer surface of the core.

At step 620, a killing function having parameters as determined in step 530 is applied. The killing function is aligned such that the maximum of the killing function is aligned with the peak corresponding to the outer surface of the core layer (determined in step 610 above), and the amplitude of the killing function is selected to be equal to the amplitude of the peak corresponding to the outer surface of a core layer.

FIG. 7B illustrates graphically how the killing function 750 is applied. The killing function is aligned at time t₀ with the signal 700 from the transducer such that the peak of the killing function aligns with the peak corresponding to outer surface of the core. The peak of the killing function A is selected to be equal to the amplitude A of the peak corresponding to the outer surface of the core. At each time t_{N} subsequent to the peak corresponding the outer surface of the core layer, a corresponding value of the killing function is subtracted from the signal obtained from the transducer, to form a modified signal 775 illustrated in FIG. 7C.

At step 630, the location of the inner surface of the core layer is determined using the modified signal. In one embodiment, the major peaks, obtained in step 610 above, may be analyzed in the following manner to determine the location of the peak corresponding to the inner surface of the core layer.

Referring to FIG. 7C, the major peaks 715a-715c having the same polarity as the peak 710a (shown in FIG. 7A) corresponding to the outer surface of the core layer are analyzed beginning with the major peak 715a located most in the direction of the inside of the article to be measured. Proceeding in a direction right to left along the signal the amplitude of each major peak is compared to the preceding major peak, until the amplitude of a major peak is lower than the previous peak (i.e., 715b is larger than 715a, but 715c is smaller than 715b). The peak 720 that corresponds to the inner surface of the core layer is then selected as the peak 720a having an opposite polarity that is located between the peaks 715b and 715c.

At step 640, the thickness of the core layer is determined. For example, a time difference between the peak corresponding to the outer surface of the core layer and the peak corresponding to the inner surface of the core layer may be multiplied by the speed of sound in the material of the core layer and divided by two to account for the round trip ultrasound wave.

It is to be appreciated that for some articles, applying a killing function according to aspects of the present invention has improved the accuracy of measurement of layer thickness, and enabled measurement of layers having thickness smaller than those measurable using conventional ultrasound techniques. For example, layers of thicknesses of about 0.0025 inches have been measured using techniques according to the present invention. Typically, techniques according to the present invention are effective for removing peaks arising from ringing that follows the peak corresponding to the skin-core interface; however if the peak corresponding to the core-skin interface overlaps the peak by a substantial amount, determination of the location of the core-skin interface may be impeded.

FIG. 9 is a schematic illustration of apparatus 900 for use with another aspect of the invention for use in measuring the layers of a multilayer article 950. Apparatus 900 includes a wave energy source 920, a transducer 930 and a processor 940. Apparatus 900 is configured such that a signal can be collected along a length L, such that the signal can be manipulated to resolve the thickness of a core layer 952 and or skin layers 954 and 956.

Transducer 930 is arranged to receive at least a portion of the wave energy reflected from article 950. Transducer 930 may be any suitable transducer of wave energy capable of generating an electronic signal corresponding to the reflected portion of the wave energy from wave energy source 920, such that each of a peak corresponding to each of the interfaces is contained, and is resolvable in the manner described below. In some embodiments, the transducer is an array sensor (e.g., a CCD or an array of photodiodes) capable of collecting wave energy to identify each of the peaks at a single time. Alternatively, one or more transducers may be translated to gather information to identify each of the peaks.

Wave energy source 920 is arranged to direct ultrasound wave energy onto an article maintained by mount, such as a mount illustrated in FIG. 4B. Wave energy source 920 may comprise any suitable source of wave energy capable of projecting wave energy onto the article such that the reflected portion of the wave energy from the wave energy source 920 that reaches the transducer results in an electronic signal having a peak corresponding to each of the interfaces is contained, and is resolvable in the manner described below. In some embodiments, it may be advantageous to have an array of sources. In such embodiments, one or more sources in the array may be illuminated at a given position relative to the article and transducer in order to obtain a suitable signal. It is to be appreciated that due to the reflective and refractive properties of the article, illumination by some of the sources in the array may not form peaks corresponding to one or more of the interfaces in the multilayer article.

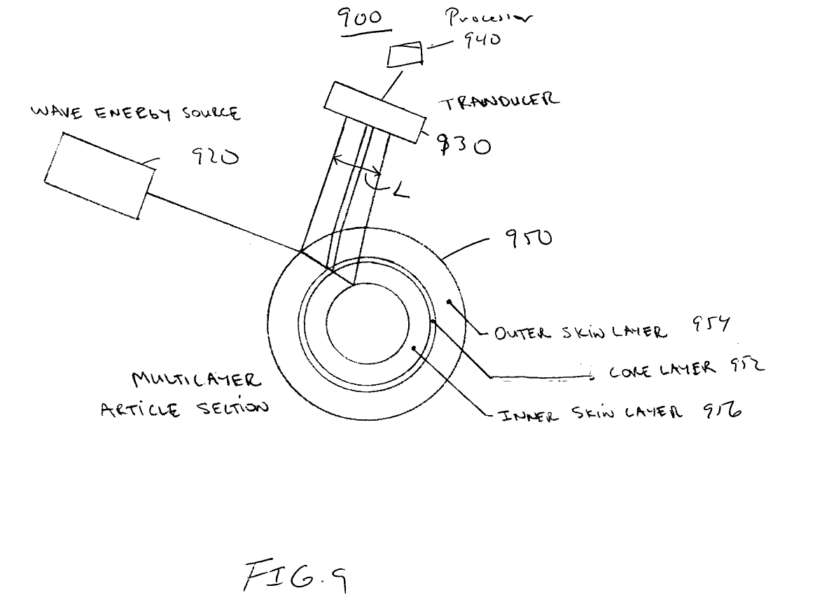

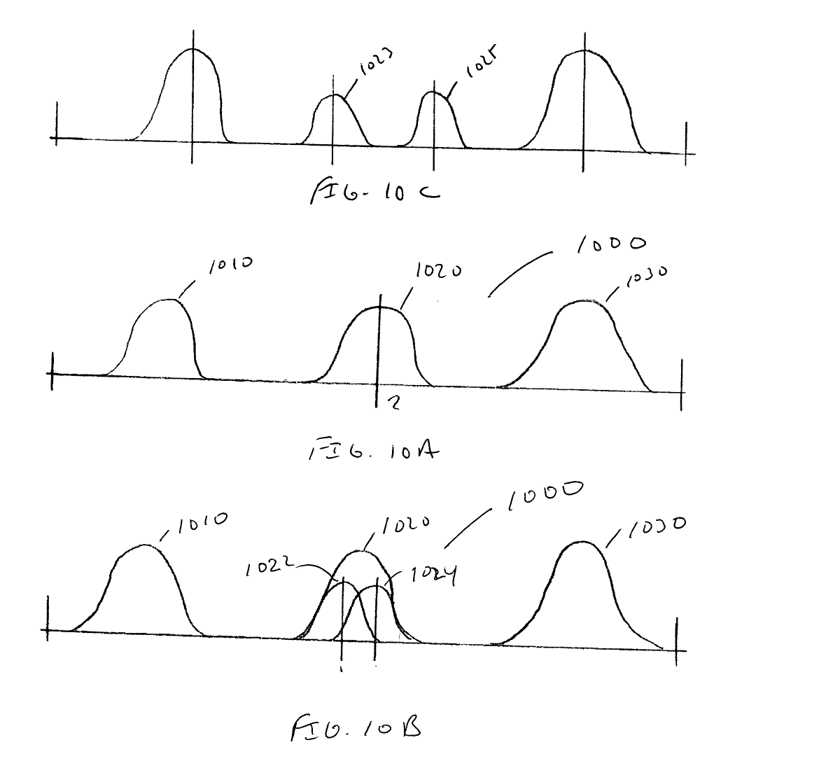

FIG. 10A illustrates an example of an electronic signal 1000 output from transducer 930 (shown in FIG. 9) containing information to permit a peak corresponding to each of the interfaces in article 950 to be identified using techniques according to aspects of the present invention as described below. For example, in a three-layer article, there is a peak 1010 corresponding to an outer skin interface; a peak 120 corresponding to a skin-core interface and a core-skin layer; and a peak corresponding to an inner skin interface 1030. FIG. 10B illustrates that the electronic signal containing information to permit a peak corresponding to each of the interfaces, and in particular, that the center peak in signal 1000 obtained from the transducer contains information both a skin-core interface and a core-skin interface such that the thickness of the core can be determined in the manner discussed below. For example, in a three-layer article, the peak 1020 includes information regarding a peak 1022 corresponding to an outer skin layer-core interface; and a peak 1024 corresponding to a core-skin interface.

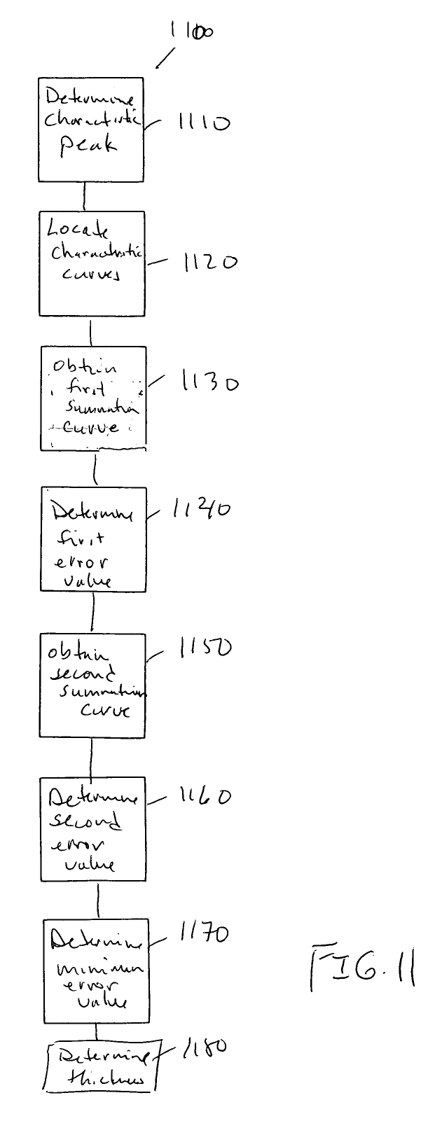

FIG. 11 is a flowchart 1100 illustrating an exemplary method for measurement of a thickness of a core layer of an article according to aspects of the present invention. At step 1110, at least a first characteristic peak is determined. For example, a characteristic peak can be determined experimentally by measuring a sample article comprised of skin layer and core layer that are comprised of the same materials as those of the preform to be measured, and where the core layer is selected to be thick enough that a peak corresponding to the skin-core interface and the peak corresponding to the core-skin interface do not overlap by a substantial amount. For example, as illustrated in FIG. 10C a signal may contain a peak 1023 corresponding to a skin-core interface and a peak 1025 corresponding to a core-skin interface. While it is typically preferable that the peaks corresponding to the skin-core interface and the core-skin interface do not overlap, any amount of overlap that does not effect execution of the method below may be used. It is to be appreciated that in some embodiments, the characteristic peaks of the skin-core interface and the core-skin interface are mirror images of one another such that only one of a characteristic peak of the skin-core interface and a characteristic peak of the core-skin interface need be obtained, and the other may be obtained by mathematical manipulation and used in the manner described below.

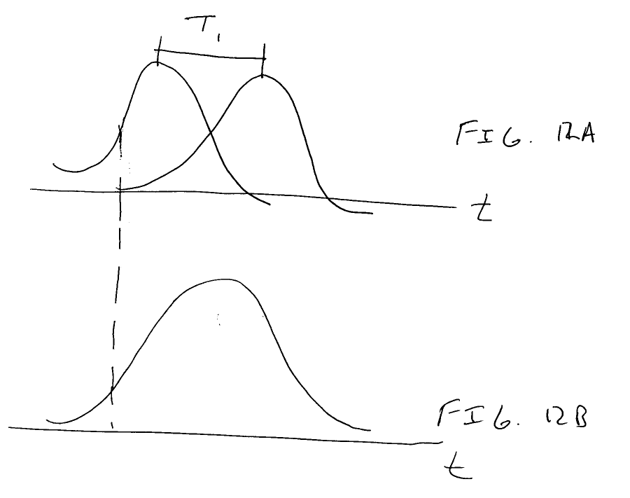

At step 1120, the characteristic peak 1023 corresponding to the skin-core interface and the peak 1025 corresponding to the core-skin interface, as determined in step 1110, are electronically manipulated to be located at locations corresponding to a first estimate of the thickness of the core. Step 1120 is graphically illustrated in FIG. 12A, where time T₁ corresponds to the first estimate of the thickness of the core.

At step 1130, the characteristic peak corresponding to the skin-core interface and the peak corresponding the core-skin interface are located at a location corresponding to a first estimate of the thickness of the core are summed at each point at each time t to form a curve, referred to herein as a summation curve. The summation curve formed for a first time t is referred to as a first summation curve. Step 1130 is graphically illustrated in FIG. 12B.

At step 1140, the first summation curve is compared to the peak corresponding to the core 1020 (shown in FIG. 10A) to determine an error value. Any suitable manner of determining error may be used. For example a least squares fit may be used.

$${\sum }_{t}^{} {( Peak ( t ) - Summation ( t ) )}^{2} = Δ Error$$

At step 1150, a second summation curve is formed for a second time T₂ corresponds to the first estimate of the thickness of the core.

At step 1160, the second summation curve is compared to the peak corresponding to the core 1020 (shown in FIG. 10A) to determine a second error value in a manner corresponding to the manner as determined at step 1140.

At step 1170, a plurality of error values are used to determine a time T_{N} corresponding to a minimum error value. A error value function can be generated as a function of time T and a function minimum can be determined. For example, a minimum may be found using Newton's Method, Euler's Method, the Method of Steepest Decent, or any other suitable method of finding a minimum. The minimum error function is taken as the time corresponding to the thickness of the core. As discussed hereinabove, a time (e.g., T_{N}) can be converted to thickness of the core using at relationship between the speed of the wave energy and time T_{N} corresponding to the minimum error (step 1180).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system to facilitate measurement, comprising:
an article mount adapted to maintain an article comprising a plurality of layers, including an outer skin layer, a core layer and an inner skin layer;
at least one wave energy source arranged to direct wave energy onto the article;
at least one transducer arranged to receive at least a portion of the wave energy reflected from the article and adapted to generate an electronic signal corresponding to the portion of the wave energy; and
a processor electronically coupled to the transducer adapted to process the electronic signal to identify a characteristic shape corresponding to an interface between two of said plurality of layers, and to determine parameters of a killing function.

2. The system of clam 1, wherein the characteristic shape is harmonic and a first peak corresponds to the first interface.

3. The system of claim 1, wherein the mount comprises a conveyor to move the article.

4. The system of claim 1, wherein the wave energy sources is a source of ultrasound.

5. The system of claim 1, wherein the article mount is adapted to maintain the article in a liquid.

6. The system of claim 1, wherein the at least one wave energy source comprises a plurality of wave energy source that are arranged in a plurality of levels.

7. The system of claim 6, wherein the at least one wave energy source comprises four wave energy sources at each level, arranged to project wave energy along two different axes.

8. The system of claim 1, wherein the at least one wave energy source is adapted to focus wave energy on the core layer.

9. A method to facilitate measurement of thickness, comprising:
mounting a co-injection article comprising a plurality of layers, including an outer skin layer, a core layer and an inner skin layer;
projecting wave energy onto the article;
receiving at least a portion of the wave energy reflected from the article;
converting the portion of the wave energy to form an electronic signal; and
processing the electronic signal to identify a characteristic shape corresponding to an interface between the layers; and
determining parameters of a killing function.

10. The method of claim 9, further comprising moving the article on a conveyor prior to the step of projecting.

11. The method of claim 9, wherein the step of projecting wave energy comprises projecting ultrasound wave energy.

12. The method of claim 9, further comprising maintaining the article in a liquid during the step of projecting wave energy.

13. The method of claim 9, wherein the step of projecting wave energy comprises projecting wave energy at a plurality of levels on the article.

14. The method of claim 9, wherein the step of projecting wave energy source comprises projecting wave energy along two different axes.

15. The method of claim 9, wherein the step of projecting wave energy comprises focusing the wave energy on the core layer.

16. The method of claim 9, wherein the characteristic shape is a peak.

17. The method of claim 16, wherein identifying the peak corresponding to the interface comprises determining major peaks and identifying a peak corresponding to the interface from among the major peaks.

18. The method of claim 9, further comprising a step of applying the killing function to the electronic signal.

19. The method of claim 18, wherein the step of applying the killing function includes setting the maximum value of the killing function equal to the maximum value of the peak corresponding to the interface.

20. The method of claim 18, wherein applying the killing function comprises aligning the killing function with a peak identified as the interface between two of the layers.

21. The method of claim 9, wherein the article is a three-layer co-polymer article.

22. The method of claim 21, wherein the layers are a skin layer and a core layer.

23. The method of claim 18, where the step of applying the killing function includes setting the maximum value of the killing function equal to the maximum value of the peak corresponding to the interface.

24. The method of claim 9, wherein the killing function is a linearly decaying sinusoid.

25. The method of claim 24, wherein the parameters include the frequency of a sinusoidal component and a slope of linear decay.

26. The method of claim 22, wherein the layers are an outer skin layer and an outer surface of the core layer.

27. The method of claim 23, further comprising a step of finding an interface between the inner surface of the core layer and an inner skin layer.

28. The method of claim 27, further comprising calculating a distance between the interface between the inner surface of the core layer and the inner skin layer, and the interface between the outer skin layer and the outer surface of the core layer.

29. A system to facilitate measurement, comprising:
an article mount adapted to maintain an article comprising a plurality of layers, including an outer skin layer, a core layer and an inner skin layer;
at least one wave energy source arranged to direct wave energy onto the article;
at least one transducer arranged to receive at least a portion of the wave energy reflected from the article and adapted to generate an electronic signal corresponding to the portion of the wave energy; and
a processor electronically coupled to the transducer adapted to process the electronic signal by subtracting a summation curve corresponding to a summation of a first characteristic peak and a second characteristic peak from the electronic signal.

30. A method to facilitate measurement of thickness, comprising:
mounting a co-injection article comprising a plurality of layers, including an outer skin layer, a core layer and an inner skin layer;
projecting wave energy onto the article;
receiving at least a portion of the wave energy reflected from the article;
converting the portion of the wave energy to form an electronic signal; and
summing a first characteristic peak and a second characteristic peak, the first characteristic peak and the second characteristic peak being separated by a first time; and
subtracting the first summation curve from the electronic signal to determine a first error value.

31. The method of claim 30, further comprising:
summing the first characteristic peak and the second characteristic peak, the first characteristic peak and the second characteristic peak being separated by a second time;
subtracting the second summation curve from the electronic signal to determine a first error value.
generating an error value function; and
calculating an error value function minimum.
